(19) United States
(12) Patent Application Publication
(10) Pub. No.: US 2020/0067094 A1
(43) Pub. Date: Feb. 27, 2020

(54) NONAQUEOUS ELECTROLYTE SECONDARY BATTERY

(71) Applicant: SANYO Electric Co., Ltd., Daito-shi, Osaka (JP)

(72) Inventors: Takaki Nakao, Osaka (JP); Yukihiro Oki, Osaka (JP)

(73) Assignee: SANYO Electric Co., Ltd., Daito-shi, Osaka (JP)

(21) Appl. No.: 16/462,752

(22) PCT Filed: Nov. 16, 2017
(86) PCT No.: PCT/JP2017/041176

§ 371 Date: May 21, 2019

(30) Foreign Application Priority Data
Nov. 29, 2016 (JP) 2016-231176

(51) Int. Cl. H01M 4/583; H01M 4/505; H01M 4/52; H01M 4/38

(52) U.S. Cl. CPC H01M 4/5835; H01M 4/505; H01M 2004/027; H01M 4/38; H01M 4/523

(57) ABSTRACT

An object of the present disclosure is to improve the discharge capacity of a nonaqueous electrolyte secondary battery using a fluoroethylene carbonate during use at low temperature. An exemplary nonaqueous electrolyte secondary battery according to an embodiment includes a positive electrode including a positive electrode current collector and a positive electrode mixture layer formed on the positive electrode current collector, a negative electrode including a negative electrode current collector and a negative electrode mixture layer formed on the negative electrode current collector, and a nonaqueous electrolyte containing a fluoroethylene carbonate. The negative electrode current collector contains a copper alloy containing iron.

### TECHNICAL FIELD

The present disclosure relates to a nonaqueous electrolyte secondary battery.

### BACKGROUND ART

Fluoroethylene carbonate (FEC) has been widely used as a solvent of a nonaqueous electrolyte in many nonaqueous electrolyte secondary batteries. FEC exhibits an effect of extending the cycle life of nonaqueous electrolyte secondary batteries. For example, Patent Literature 1 discloses a nonaqueous electrolyte secondary battery in which FEC is contained as a solvent in the nonaqueous electrolyte solution, and the viscosity of the nonaqueous electrolyte solution is equal to or less than 2.5 mPas.

### CITATION LIST

### Patent Literature

PTL 1: Japanese Published Unexamined Patent Application No. 2008-270147

### SUMMARY OF INVENTION

### Technical Problem

Nonaqueous electrolyte secondary batteries have been increasingly used in low-temperature environments. In nonaqueous electrolyte secondary batteries using FEC, a coating containing a reduced product is formed on the negative electrode. This improves cycle characteristics during charging/discharging in a normal-temperature environment and in a high-temperature environment. On the other hand, in a low-temperature environment, the discharge capacity decreases during charging/discharging, thereby degrading the cycle characteristics.

### Solution to Problem

A nonaqueous electrolyte secondary battery according to one aspect of the present disclosure includes a positive electrode including a positive electrode current collector and a positive electrode mixture layer formed on the positive electrode current collector, a negative electrode including a negative electrode current collector and a negative electrode mixture layer formed on the negative electrode current collector, and a nonaqueous electrolyte containing a fluoroethylene carbonate. The negative electrode current collector contains a copper alloy containing iron.

### Advantageous Effects of Invention

According to one aspect of the present disclosure, the discharge capacity of a nonaqueous electrolyte secondary battery using FEC can be improved during use at low temperature.

### BRIEF DESCRIPTION OF DRAWINGS

FIG. 1 is a cross section of an exemplary nonaqueous electrolyte secondary battery according to an embodiment.

### DESCRIPTION OF EMBODIMENTS

A demand for energy storage systems used, for example, in cold climates has been growing. Accordingly, nonaqueous electrolyte secondary batteries have been increasingly used in low-temperature environments. As described above, fluoroethylene carbonate (FEC) is widely used as the solvent of a nonaqueous electrolyte to improve the cycle characteristics of the batteries. However, the present inventors studied and found that with the presence of FEC, the discharge capacity decreases during use at low temperature. Energy storage systems used in cold climates may be exposed to high temperatures in summer. Thus, in various applications including such energy storage systems, the cycle life during use at normal temperature and high temperature is to be considered. Accordingly, it is not desirable that FEC not be used.

The present inventors found that using a negative electrode current collector that contains a copper alloy containing iron in a nonaqueous electrolyte secondary battery containing FEC specifically improves the discharge capacity during use at low temperature. It is presumed that when such a negative electrode current collector is used, a reduced lithium-containing substance generated during charging at low temperature extends thinly over the entire negative electrode surface and is uniformly deposited and thus, the irreversible capacity decreases, thereby improving the discharge capacity during use at low temperature. A negative electrode current collector that contains a copper alloy containing iron readily extends compared with a typical negative electrode current collector that contains pure copper. Thus, in a nonaqueous electrolyte secondary battery according to the present disclosure, an increase in pressure in the electrode group is likely to be suppressed during charging/discharging and the electrolyte solution be readily distributed uniformly in the electrode group. It is presumed that the uniform distribution of the electrolyte solution in the electrode group leads to the uniform deposition of the reduced lithium-containing substance on the negative electrode surface.

When a typical negative electrode current collector containing pure copper is used in a nonaqueous electrolyte secondary battery containing FEC, the reduced lithium-containing substance forms a thick deposition on a specific place of the negative electrode surface during charging at low temperature. For example, it has been found that in an electrode body having a winding structure, a reduced lithium-containing substance readily forms a thick deposition locally on the end portion at which winding of the negative electrode ends. The nonuniform presence of the reduced substance is likely to be a primary cause of the decrease in the discharge capacity of a conventional nonaqueous electrolyte secondary battery containing FEC during use at low temperature.

Hereinafter, as an example of an embodiment, a nonaqueous electrolyte secondary battery 10, which is a cylindrical battery including a cylindrical metal case, will be described; however, the nonaqueous electrolyte secondary battery according to the present disclosure is not limited thereto. The nonaqueous electrolyte secondary battery according to the present disclosure may be a prismatic battery including a prismatic metal case or a laminate battery including an exterior member formed of a resin sheet. As an electrode body included in the nonaqueous electrolyte secondary battery, a wound-type electrode body 14, in which the positive electrode and the negative electrode are wound with the separator disposed therebetween, will be described; however, the electrode body is not limited thereto. The electrode body may be a stacked-type electrode body in which a plurality of positive electrodes and a plurality of negative electrodes are alternately stacked on each other with the separator therebetween.

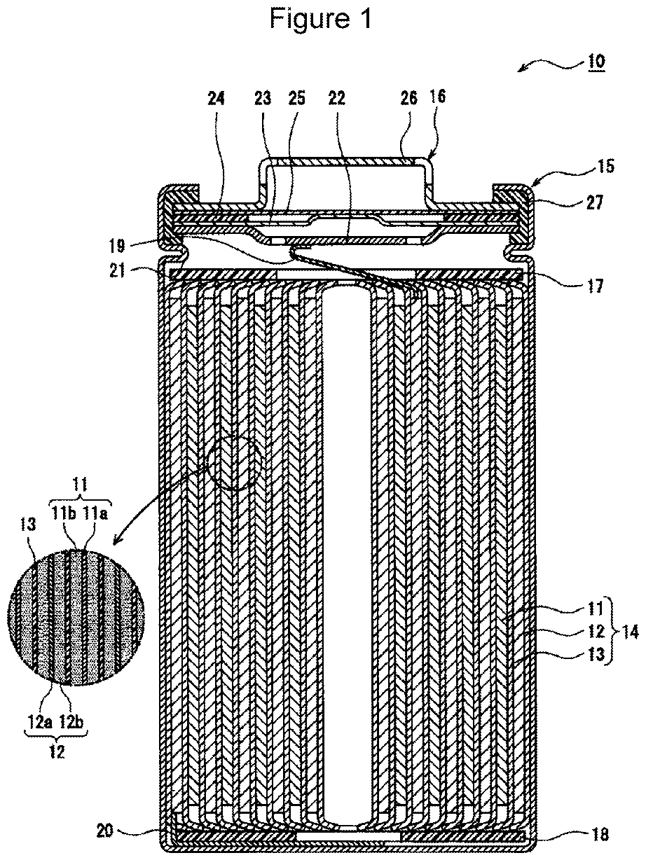

FIG. 1 is a cross section of the nonaqueous electrolyte secondary battery 10. As illustrated in FIG. 1, the nonaqueous electrolyte secondary battery 10 includes the electrode body 14 having a winding structure and includes a nonaqueous electrolyte (not shown). The electrode body 14 includes a positive electrode 11, a negative electrode 12, and a separator 13 and is formed by spirally winding the positive electrode 11 and the negative electrode 12 with the separator 13 disposed therebetween. Hereinafter, one side of the electrode body 14 in an axial direction may be stated as “upper”, and the other side in the axial direction may be stated as “lower”.

The positive electrode 11, the negative electrode 12, and the separator 13, which are included in the electrode body 14, are each formed in a strip-shape and are spirally wound so as to be alternately stacked in a radial direction of the electrode body 14. In the electrode body 14, the longitudinal direction of the electrodes is the winding direction. The width direction of the electrodes is the axial direction. A positive electrode lead 19 electrically connecting the positive electrode 11 and the positive electrode terminal to each other is, for example, connected to the center portion of the positive electrode 11 in the longitudinal direction and extended from the upper end of the electrode group. A negative electrode lead 20 electrically connecting the negative electrode 12 and the negative electrode terminal to each other is, for example, connected to the end portion of the negative electrode 12 in the longitudinal direction and extended from the lower end of the electrode group.

In the example illustrated in FIG. 1, a metal battery case encasing the electrode body 14 and the nonaqueous electrolyte includes a case main body 15 and a sealing body 16. An insulating plate 17 is disposed on the upper side of the electrode body 14, and an insulating plate 18 is disposed on the lower side of the electrode body 14. The positive electrode lead 19 extends toward the sealing body 16 through the through hole of the insulating plate 17 and is welded to the lower surface of a filter 22, which is the bottom plate of the sealing body 16. In the nonaqueous electrolyte secondary battery 10, a cap 26 of the sealing body 16 electrically connected to the filter 22 is the positive electrode terminal. On the other hand, the negative electrode lead 20 extends toward a bottom portion of the case main body 15 and is welded to the inner surface of the bottom portion of the case main body 15. In the nonaqueous electrolyte secondary battery 10, the case main body 15 is the negative electrode terminal.

The case main body 15 is a closed-end cylindrical metal container. Between the case main body 15 and the sealing body 16, a gasket 27 is disposed to reliably seal the battery case. The case main body 15 includes a protruded portion 21 supporting the sealing body 16. For example, the protruded portion 21 is formed by pressing a side surface portion from outside. The protruded portion 21 is preferably formed in a circumferential direction of the case main body 15 to be annular. The upper surface of the protruded portion 21 supports the sealing body 16.

The sealing body 16 has a structure in which the filter 22, a lower valve body 23, an insulating member 24, an upper valve body 25, and the cap 26 are stacked on each other in this order from the electrode-body-14 side. The members included in the sealing body 16 each have a disk shape or an annular shape, for example. The members other than the insulating member 24 are electrically connected to each other. The center portion of the lower valve body 23 and the center portion of the upper valve body 25 are connected to each other. The insulating member 24 is disposed between the peripheral portion of the lower valve body 23 and the peripheral portion of the upper valve body 25. The lower valve body 23 has a vent. Thus, when the inner pressure of the battery increases due to abnormal heat generation, the upper valve body 25 expands toward the cap 26 and separates from the lower valve body 23, thereby blocking the electrical connection between the upper valve body 25 and the lower valve body 23. If the inner pressure further increases, the upper valve body 25 is fractured, and the gas is discharged from the opening of the cap 26.

Hereinafter, the components of the electrode body 14 (the positive electrode 11, the negative electrode 12, and the separator 13) and the nonaqueous electrolyte will be fully described.

### Positive Electrode

The positive electrode 11 includes a positive electrode current collector 11a and a positive electrode mixture layer 11b formed on the positive electrode current collector 11a. As the positive electrode current collector 11a, for example, a metal foil that is stable within the electric potential of the positive electrode 11, such as an aluminum foil, or a film having such a metal on the surface thereof may be used. The positive electrode mixture layer 11b preferably contains a conductive material and a resin binder in addition to a positive electrode active material. The positive electrode 11 can be produced, for example, by applying a positive electrode mixture slurry containing materials, such as a positive electrode active material, a conductive material, and a resin binder, to the positive electrode current collector 11a, drying the coating, and thereafter, performing rolling, to form the positive electrode mixture layer 11b on each surface of the current collector.

The positive electrode active material contains a lithium transition metal oxide that is the main constituent thereof. The positive electrode active material may contain substantially only a lithium transition metal oxide or may contain a lithium transition metal oxide having a particle surface to which inorganic compound particles, such as aluminum oxide particles or lanthanoid-containing compound particles, adhere. The lithium transition metal oxides may be used alone or in a combination of two or more.

Examples of the metal element contained in the lithium transition metal oxide include nickel (Ni), cobalt (Co), manganese (Mn), aluminum (Al), boron (B), magnesium (Mg), titanium (Ti), vanadium (V), chromium (Cr), iron (Fe), copper (Cu), zinc (Zn), gallium (Ga), strontium (Sr), zirconium (Zr), niobium (Nb), indium (In), tin (Sn), tantalum (Ta), and tungsten (W). An exemplary preferable lithium transition metal oxide is a lithium nickel manganese cobalt oxide expressed by the general formula Li_{α}NiₓMn_{y}Co_{z}O₂ (0<α≤1.2, x+y+z=1, x≥y>0, x≥z>0). Using such a lithium nickel manganese cobalt oxide as the positive electrode active material further improves the discharge capacity of the nonaqueous electrolyte secondary battery during use at low temperature.

The conductive material contained in the positive electrode mixture layer 11b may be a carbon material, such as carbon black, acetylene black, KETJENBLACK, or graphite. The resin binder contained in the positive electrode mixture layer 11b may be a fluororesin, such as polytetrafluoroethylene (PTFE) or polyvinylidene fluoride (PVdF), polyacrylonitrile (PAN), a polyimide resin, an acrylic resin, or a polyolefin resin. Such a resin, a cellulose derivative, such as carboxymethyl cellulose (CMC) or a salt thereof, and polyethylene oxide (PEO) may be used in combination.

### Negative Electrode

The negative electrode 12 includes a negative electrode current collector 12a and a negative electrode mixture layer 12b formed on the negative electrode current collector 12a. The negative electrode current collector 12a contains a copper alloy containing iron. The negative electrode mixture layer 12b preferably contains a resin binder in addition to a negative electrode active material. The negative electrode 12 can be produced, for example, by applying a negative electrode mixture slurry containing materials, such as a negative electrode active material and a resin binder, to the negative electrode current collector 12a, drying the coating, and thereafter, performing rolling, to form the negative electrode mixture layer 12b on each surface of the current collector.

The negative electrode active material may be any material that reversibly includes and releases lithium ions. As the negative electrode active material, a carbon material, such as natural graphite or synthetic graphite, a metal that is alloyed with lithium, such as silicon (Si) or tin (Sn), or an oxide containing a metal element, such as Si or Sn, may be used. The negative electrode active materials may be used alone or in a combination of two or more.

As the resin binder contained in the negative electrode mixture layer 12b, a fluororesin, PAN, a polyimide resin, an acrylic resin, or a polyolefin resin may be used in the same manner as in the positive electrode. In a preparation of the mixture slurry with an aqueous solvent, CMC or a salt thereof, styrene-butadiene rubber (SBR), polyacrylic acid (PAA) or a salt thereof, or polyvinyl alcohol is preferably used.

As described above, the negative electrode current collector 12a contains a copper alloy containing iron (hereinafter, referred to as “Cu—Fe alloy”). In the Cu—Fe alloy, Cu is the main constituent, and a small amount of Fe is contained. The negative electrode current collector 12a may be a film having the Cu—Fe alloy on the surface thereof and is preferably a Cu—Fe alloy foil. The Cu—Fe alloy foil has a thickness of, for example, 5 μm to 15 μm. As described above, using the Cu—Fe alloy foil as the negative electrode current collector 12a with the presence of a nonaqueous solvent containing FEC specifically improves the discharge capacity of the battery during use at low temperature.

The Cu—Fe alloy contained in the negative electrode current collector 12a may contain a constituent other than Cu and Fe or may contain substantially only Cu and Fe. The amount of Fe in the Cu—Fe alloy is preferably more than 0.02 mass % and 2 mass % or less and more preferably 0.1 mass % to 2 mass % (0.1 mass % or more and 2 mass % or less) relative to the mass of the Cu—Fe alloy. It is not preferable that the amount of Fe be significantly increased, since due to such a large amount, the strength of the negative electrode current collector 12a deteriorates, and thus, the current collector readily fractures. On the other hand, it is not preferable that the amount of Fe be significantly decreased, since due to such a small amount, the effect of improving the discharge capacity during use at low temperature is reduced. The amount of Fe is within the above range, and thus, the appropriate strength of the negative electrode current collector 12a is retained and the discharge capacity during use at low temperature readily improves.

The amount of Cu in the Cu—Fe alloy is preferably 98 mass % or more and less than 99.98 mass % relative to the mass of the Cu—Fe alloy. When the Cu—Fe alloy contains a constituent other than Cu and Fe, the amount of constituent is preferably less than the amount of Fe.

### Separator

As the separator 13, a porous sheet having ion permeability and insulating properties is used. Specific examples of the porous sheet include micro-porous thin films, fabric, and nonwoven fabric. The material of the separator 13 is preferably an olefin resin, such as polyethylene or polypropylene, or cellulose. The separator 13 may have a monolayer structure or a stacked structure. The separator 13 may have a surface on which a heat-resistant layer containing a heat-resistant material is formed. Examples of the heat-resistant material include polyamide resins, such as aliphatic polyamides and aromatic polyamides (aramids), polyimide resins, such as polyamide imides and polyimides.

### Nonaqueous Electrolyte

The nonaqueous electrolyte contains a nonaqueous solvent and an electrolyte salt dissolved in the nonaqueous solvent. The nonaqueous solvent contains at least FEC. The amount of FEC is preferably 2 volume % to 40 volume % (2 volume % or more and 40 volume % or less) and more preferably 10 volume % to 35 volume % relative to the volume of the nonaqueous solvent. The amount of FEC is within the above range, and thus, good cycle characteristics are readily retained during use in a low-temperature to high-temperature environment. The nonaqueous solvent preferably further contains at least one of fluorine-based solvents other than FEC and non-fluorine-based solvents. The nonaqueous electrolyte is not limited to a liquid electrolyte (nonaqueous electrolyte solution) and may be a solid electrolyte produced by using, for example, a gel polymer. The nonaqueous electrolyte may contain an additive, such as vinylene carbonate (VC), ethylene sulfite (ES), cyclohexylbenzene (CHB), or a modified form thereof.

Examples of the FEC include 4-fluoroethylene carbonate (monofluoroethylene carbonate), 4,5-difluoroethylene carbonate, 4,4-difluoroethylene carbonate, 4,4,5-trifluoroethylene carbonate, and 4,4,5,5-tetrafluoroethylene carbonate. Among these compounds, 4-fluoroethylene carbonate is particularly preferable.

Examples of the nonaqueous solvent other than FEC include, cyclic carbonates, linear carbonates, cyclic ethers, linear ethers, carboxyl acid esters, such as methyl acetate, ethyl acetate, propyl acetate, methyl propionate, ethyl propionate, and γ-butyrolactone, nitriles, such as acetonitrile, amides, such as dimethylformamide, and halogen-substituted derivatives in which hydrogen atoms of the above compounds are substituted by halogen atoms, such as fluorine atoms. These compounds may be used alone or in a combination of two or more.

Examples of the cyclic carbonates include ethylene carbonates (EC), propylene carbonates, and butylene carbonates. Among these compounds, EC is particularly preferable. Examples of the linear carbonates include dimethyl carbonates (DMC), ethylmethyl carbonates (EMC), diethyl carbonates, methylpropyl carbonates, ethylpropyl carbonates, and methylisopropyl carbonates. Among these compounds, DMC and EMC are particularly preferable.

Examples of the cyclic ethers include 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol, and crown ethers. Examples of the linear ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, tetraethylene glycol dimethyl ether.

An exemplary preferable nonaqueous solvent is a combination of FEC and a non-fluorine-based solvent containing at least one of EC, EMC, and DMC. In such a case, the amount of EC is preferably 10 volume % to 30 volume % relative to the volume of the nonaqueous solvent. The amount of EMC is preferably 20 volume % to 40 volume % relative to the volume of the nonaqueous solvent. The amount of DMC is preferably 20 volume % to 40 volume % relative to the volume of the nonaqueous solvent.

The electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (1<x<6, n equals 1 or 2), LiB₁₀Cl₁₀, LiCl, LiBr, LiI, chloroborane lithium, lower aliphatic lithium carboxylates, boric acid salts, such as Li₂B₄O₇ and Li(B(C₂O₄)F₂), and imide salts, such as LiN(SO₂CF₃)₂, LiN(C₁F₂ₗ₊₁SO₂)(CₘF₂ₘ₊₁SO₂) {l and m are each an integer equal to or greater than 1}. Such lithium salts may be used alone or in a combination of two or more. Among these compounds, from the viewpoint of, for example, ion conductivity and electrochemical stability, LiPF₆ is preferably used. The concentration of the lithium salt is, for example, 0.8 to 1.8 mol per one liter of the nonaqueous solvent.

### EXAMPLES

Hereinafter, the present disclosure will be further described with reference to examples. The present disclosure is not limited to such examples.

### Example 1

### Production of Positive Electrode

As the positive electrode active material, a lithium nickel manganese cobalt oxide expressed by LiNi_{0.5}Mn_{0.3}Co_{0.2}O₂ was used. Mixing of 95 parts by mass of the positive electrode active material, 2 parts by mass of acetylene black, 3 parts by mass of polyvinylidene fluoride, and an appropriate amount of N-methyl-2-pyrrolidone (NMP) was performed to prepare a positive electrode mixture slurry. Next, the positive electrode mixture slurry was applied to each surface of a positive electrode current collector formed of an aluminum foil having a thickness of 13 μm. The current collector, on which the coatings had been formed, was heat-treated at a temperature of 100° C. to 150° C. to remove NMP. Thereafter, the coatings were pressed by using a roll press machine such that the electrode plate including the current collector and the mixture layers had a thickness of 0.15 mm, to form the positive electrode mixture layer. The current collector, on each surface of which the positive electrode mixture layer had been formed, was cut into a predetermined electrode size to provide a positive electrode.

### Production of Negative Electrode

Mixing of 96 parts by mass of graphite powder as the negative electrode active material, 2 parts by mass of styrene butadiene rubber, and 2 parts by mass of carboxymethyl cellulose was performed, and an appropriate amount of water was further added to prepare a negative electrode mixture slurry. Next, the negative electrode mixture slurry was applied to each surface of a negative electrode current collector formed of a Cu—Fe alloy foil having a thickness of 10 μm. The current collector, on which the coatings had been formed, was heat-treated at a temperature of 100° C. to 150° C. to remove water. Thereafter, the coatings were pressed by using a roll press machine such that the electrode plate including the current collector and the mixture layers had a thickness of 0.16 mm, to form a negative electrode mixture layer. The current collector, on each surface of which the negative electrode mixture layer had been formed, was cut into a predetermined electrode size to provide a negative electrode.

The Cu—Fe alloy contained in the negative electrode current collector contains substantially only Cu and Fe and has a Fe content of 0.02 mass %. The amount of Fe in the Cu—Fe alloy is measured by inductively coupled plasma (ICP) emission spectrochemical analysis.

### Preparation of Nonaqueous Electrolyte Solution

FEC, EC, EMC, and DMC were mixed at a volume ratio of 10:25:30:35. LiPF₆ was dissolved in the solvent mixture so as to have a concentration of 1.4 mol/L. Thereafter, vinylene carbonate (VC) was added so as to have a concentration of 2 weight % (relative to the weight of the nonaqueous electrolyte solution), to prepare a nonaqueous electrolyte solution.

### Production of Battery

An aluminum lead was attached to the positive electrode, and a nickel lead was attached to the negative electrode. The positive electrode and the negative electrode were spirally wound with a separator disposed therebetween to produce a wound-type electrode body. After encasing the electrode body in a closed-end cylindrical battery-case main body having a diameter of 18 mm and a height of 65 mm and pouring the nonaqueous electrolyte solution into the main body, the opening of the battery-case main body was sealed with a gasket and a sealing body to produce a 18650-type, cylindrical nonaqueous electrolyte secondary battery having a battery capacity of 2300 mAh.

### Example 2

A nonaqueous electrolyte secondary battery was produced in the same manner as in Example 1, except that a Cu—Fe alloy foil having a Fe content of 2.0 mass % was used as the negative electrode current collector and that a mixture in which FEC, EC, EMC, and DMC were mixed at a volume ratio of 40:10:30:20 was used as the nonaqueous solvent of the nonaqueous electrolyte solution.

### Comparative Example 1

A nonaqueous electrolyte secondary battery was produced in the same manner as in Example 1, except that a pure copper foil (Fe content 0%) was used as the negative electrode current collector.

### Comparative Example 2

A nonaqueous electrolyte secondary battery was produced in the same manner as in Comparative Example 1, except that a mixture in which EC, EMC, and DMC were mixed at a volume ratio of 35:30:35 was used as the nonaqueous solvent of the nonaqueous electrolyte solution.

### Comparative Example 3

A nonaqueous electrolyte secondary battery was produced in the same manner as in Example 1, except that a mixture in which EC, EMC, and DMC were mixed at a volume ratio of 35:30:35 was used as the nonaqueous solvent of the nonaqueous electrolyte solution.

### Comparative Example 4

A nonaqueous electrolyte secondary battery was produced in the same manner as in Example 2, except that a pure copper foil (Fe content 0%) was used as the negative electrode current collector.

The properties of the above nonaqueous electrolyte secondary batteries were evaluated by the following method, and the evaluation results are summarized in Table 1. Table 1 shows the evaluation results and in addition, the amount of FEC in the nonaqueous solvent, and the amount of Fe in the metal foil, which forms the negative electrode current collector and in which copper is the main constituent.

### Evaluation of Discharge Capacity during Use at Low Temperature

Under a condition of a temperature of 0° C., a battery was charged by CCCV charging at a current of 2300 mA to a battery voltage of 4.1 V (cut-off current: 46 mA), which was followed by a 10-minute pause, and thereafter, the battery was discharged by CC discharging at a discharge current of 2300 mA to a battery voltage of 3.0 V, which was followed by a 10-minute pause. Such a charging/discharging cycle was repeatedly performed for three cycles, and the discharge capacity at the third cycle was determined.

### Evaluation of Cycle Characteristics (25° C.)

Under a condition of a temperature of 25° C., a battery was charged by CCCV charging at a current of 2300 mA to a battery voltage of 4.1 V (cut-off current: 46 mA), which was followed by a 10-minute pause, and thereafter, the battery was discharged by CC discharging at a discharge current of 2300 mA to a battery voltage of 3.0 V, which was followed by a 10-minute pause. Such a charging/discharging cycle was repeatedly performed for 600 cycles, and the ratio of the discharge capacity at the 600th cycle to the discharge capacity at the first cycle (discharge capacity retention ratio) was determined.

TABLE 1

| | | | Low- | Discharge |
|---|---|---|---|---|
| | Amount | Amount of | temperature | capacity |
| | of FEC | Fe | cycle discharge | retention ratio |
| | (volume %) | (mass %) | capacity (mAh) | at 25° C. (%) |
| Example 1 | 10 | 0.02 | 1420 | 90 |
| Example 2 | 40 | 2.0 | 1383 | 92 |
| Comparative | 10 | 0 | 1330 | 89 |
| Example 1 | | | | |
| Comparative | 0 | 0 | 1460 | 78 |
| Example 2 | | | | |
| Comparative | 0 | 0.02 | 1450 | 80 |
| Example 3 | | | | |
| Comparative | 40 | 0 | 1302 | 90 |
| Example 4 | | | | |

As shown in Table 1, the batteries in Examples 1 and 2 have higher discharge capacity than the batteries in Comparative Examples 1 and 4 during use at low temperature. In addition, the cycle characteristics at 25° C. of the batteries in Examples 1 and 2 are higher than those of the batteries in Comparative Examples 1 and 4. The batteries using no FEC in Comparative Examples 2 and 3 have good discharge capacity during use at low temperature; however, the cycle characteristics (discharge capacity retention ratio) thereof at 25° C. decrease to 80% or less. These results apparently show that using a negative electrode current collector containing a Cu—Fe alloy with the presence of FEC leads to high discharge capacity during use at low temperature and good cycle characteristics during use at normal temperature.

### REFERENCE SIGNS LIST

10 nonaqueous electrolyte secondary battery
11 positive electrode
11a positive electrode current collector
11b positive electrode mixture layer
12 negative electrode
12a negative electrode current collector
12b negative electrode mixture layer
13 separator
14 electrode body
15 case main body
16 sealing body
17, 18 insulating plate
19 positive electrode lead
20 negative electrode lead
21 protruded portion
22 filter
23 lower valve body
24 insulating member
25 upper valve body
26 cap
27 gasket

1. A nonaqueous electrolyte secondary battery comprising:
a positive electrode including a positive electrode current collector and a positive electrode mixture layer formed on the positive electrode current collector;
a negative electrode including a negative electrode current collector and a negative electrode mixture layer formed on the negative electrode current collector; and
a nonaqueous electrolyte containing a fluoroethylene carbonate,
wherein the negative electrode current collector contains a copper alloy containing iron.

2. The nonaqueous electrolyte secondary battery according to claim 1, wherein an amount of the fluoroethylene carbonate in a nonaqueous solvent of the nonaqueous electrolyte is 2 volume % to 40 volume % relative to the volume of the nonaqueous solvent.

3. The nonaqueous electrolyte secondary battery according to claim 1, wherein an amount of the iron in the copper alloy is more than 0.02 mass % and 2 mass % or less relative to the mass of the copper alloy.

4. The nonaqueous electrolyte secondary battery according to claim 1, wherein the positive electrode contains a positive electrode active material that is a lithium nickel manganese cobalt oxide expressed by a general formula Li_{α}NiₓMn_{y}Co₂O₂ (0<α≤1.2, x+y+z=1, x≥y>0, x≥z>0).
